(19) United States
(12) Patent Application Publication
(10) Pub. No.: US 2007/0133505 A1
(43) Pub. Date: Jun. 14, 2007

(54) Distribution of short messages using a video control device

(76) Inventors: Stefan Kuchenhoff, Oberhaching (DE); Stefan Unger, Unterhaching (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/587,629

(22) PCT Filed: Jan. 11, 2005
(86) PCT No.: PCT/EP05/50090

§ 371 Date: Jul. 28, 2006

(30) Foreign Application Priority Data
Jan. 29, 2004 (DE) 10 2004 004 518.6

(51) Int. Cl. H04L 12/66; H04H 1/04

(52) U.S. Cl. 370/352; 370/486

(57) ABSTRACT

In one aspect a system for transferring messages from a communication unit such as a phone, a cellular or mobile phone, a personal computer, a digital camera, or a digital video camera to other compatible systems such as digital set-top boxes, multimedia terminals, digital TV receivers or digital TVs is provided The system communication unit and a television device, by utilizing a base station in a wireless communications network, a communications provider connecting to the base station, a television network operator operating a television distribution network, and a television device.

### CROSS REFERENCE TO RELATED APPLICATIONS

This application is the US National Stage of International Application No. PCT/EP2005/050090, filed Jan. 11, 2005 and claims the benefit thereof. The International Application claims the benefits of German application No. 102004004518.6 DE filed Jan. 29, 2004, both of the applications are incorporated by reference herein in their entirety.

### FIELD OF INVENTION

The present invention relates to a distribution of short messages using a video control device.

### BRIEF DESCRIPTION OF THE DRAWINGS

FIG. 1 illustrates an exemplary embodiment of a system in accordance with the present invention; and

FIG. 2 illulstrates an exemplary embodiment of message flows in accordance with the present invention.

### DETAILED DESCRIPTION OF INVENTION

In an IP-based network with video-centric services, i.e. services with which a main part of the information is transmitted as a video data stream (e.g. the “video on demand” service) it should be possible to send an individual user (Tln) a short message, e.g. a short message without images/sounds by means of the short message service (SMS) or to send a short message with images/sounds using the multimedia message service (MMS) or the user should be allowed to send a short message. In accordance with the invention, this functionality is made available with the aid of the control server for the video services and integrated into the video image displayed on the TV set.

Present video networks are mainly cable based. IP-based video networks are relatively new and are at present being implemented worldwide. Solutions that enable a user to individually send or receive short messages are as yet unknown for either IP- or cable-based networks.

Previous applications to integrate SMS messages in video transmission have been limited to limiting the ability of the particular user to send an SMS to a special number by means of a mobile radio device and for the content of the SMS to be then broadcast to all users, superimposed on the radiated TV image as overlaid text.

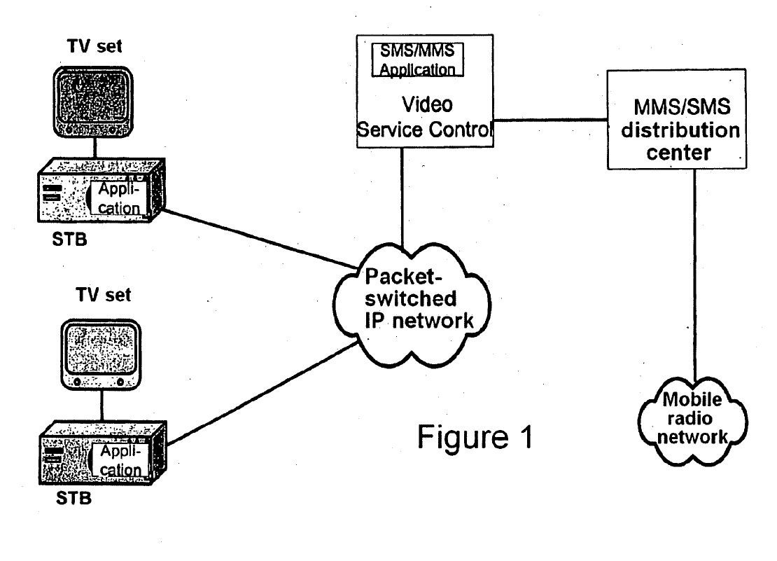

FIG. 1 shows an example of the invention, that is explained in more detail in the following.

In an IP-based network with video-centric services a central video control device, e.g. a video control server, typically controls the video services. This video control server manages the individual video users and their service profiles, controls the billing and controls the graphical user interface (GUI)displayed by means of the TV set connected to the set top box (STB). To control or select the services, a communication link, e.g. HTTP based, is provided between the client on the STB and the video control server.

The method in accordance with the invention provides for the video control server to also support, as a new type of service, the reception and/or transmission of short messages by a suitable application, e.g. an SMS/MMS application. For this purpose, the video Tln should be addressed by means of a standard PSTN call number. To do this, the video Tln subscribes to the video control server by means of its PSTN call number. Optionally, the addressing of the video Tln can also be purely IP based, e.g. by means of a URI (e.g. teilnehmer@domain.de). In this case, the SMS/MMS distribution center will also have to have supported the transmission of SMS/MMS to such IP-based addresses.

Present day SMS/MMS distribution centers also support the transmission of SMS to PSTN Tln. The PSTN Tln in this case is addressed by means of its normal PSTN call number. At present this requires either special terminals (SMS in that case is transmitted, inband coded, using special protocols) or the SMS is converted into language in the distribution center and read to the PSTN Tln. MMS to PSTN Tln also requires a special terminal, moreover the distribution center for example sets up a voice channel and then sends the MMS to this via a modem link.

The method in accordance with the invention furthermore provides that the video control server logs on to the SMS/MMS distribution center in the name of all the video Tln managed by it. The PSTN call number of the video Tln is thus made known to the distribution center. A new feature is that the entry in the distribution center takes place in such a way that the PSTN Tln can be reached via the video control server, i.e. the video control server acts as the “gateway” through which an SMS/MMS can be provided to the PSTN Tln (the video control server terminates the SMS/MMS protocol of the public network and converts it to a format suitable for forwarding the SMS/MMS content to the application on the STB). The transmission of the SMS and MMS between the distribution center and video control server takes place through a suitable interface, e.g. IP based.

The video control server contains an application for receiving and/or transmitting the SMS/MMS in accordance with SMS/MMS standards, i.e. the video control server contains the SMS/MMS application for all the video Tln managed by it. Because the video control server terminates the SMS/MMS signaling in this application, an SMS/MMS transmitted to the video control server is also considered as successfully delivered.

The transmission of the actual content of the SMS/MMS to the video Tln takes place via an IP-based interface between the video control server and the STB, e.g. XML coded. According to the invention, the STB contains an application for this that can exchange actual data content of the SMS/MMS with the particular SMS/MMS application on the video control server.

If the STB is online, i.e. has an IP connection, the application logs on to the STB for the SMS/MMS application on the video control server. As long as the STB is online, the STB can receive the SMS/MMS. The STB application changes the received data into a form that can be displayed as an image on the TV set connected to the STB. For an SMS, the characters contained are shown as text. For an MMS, the images contained and the characters are shown as an image with text. This image can then also be overlaid by an existing video image by the STB (note: present STB including present SW clients for video services support the required “alpha blending” technology for overlaying video images). If the STB is online but the TV set is switched off, several options are possible, as follows.
The STB stores the SMS/MMS contact temporarily and when the TV set is switched on displays a notice of received SMS/MMS in the form of a video image.
The STB temporarily stores the SMS/MMS content and outputs an indication of received SMS/MMS to the STB (light on, sound via speaker).
The STB automatically switches on a TV set connected via a SCART (provided the TV set supports this and is in standby mode).

The IP-based interface between the video control server and the STB also enables the transmission of an acknowledgement that the Tln has read the SMS/MMS.

If the STB is not online, this is indicated to the video control server by the absence of a logon of the STB allocation. In this case, all received SMS/MMS are stored in the SMS/MMS application of the Tln. On the next logon of the STB application these SMS/MMS are provided in sequence to the Tln via the STB.

The transmission of SMS/MMS takes place in principle via the same paths as previously described. Present STBs, for example, enable text input from IR keyboards. Depending on the facilities of the STB, image information can be input for MMS, e.g. the actual TV image to be transmitted, recordings of an image via a camera connected to the STB, image information stored on an internal hard disk or also on a storage medium that can be plugged into the STB (e.g. USB stick, flash memory card). The last option also permits the import of SMS/MMS messages that are received by a mobile radio device provided the mobile radio device has an external storage medium.

The STB application combines input text and image information and sends this to the SMS/MMS client in the video control server, from where it is forwarded in a suitable format for further onward transmission to the distribution center.

SMS/MMS can be sent via PSTN to a special PSTN terminal. However, this requires a special terminal that can display SMS and supports the connection and control of a TV set. Furthermore, this typically requires a subscription to the CLIP service, which incurs additional costs particularly for analog PSTN Tln. For MMS, the image information must be fetched from the terminal by means of a modem connection and can then be displayed on a connected TV set. However, the transmission of MMS through terminals of this kind is at present not possible.

The SMS/MMS distribution center could transmit SMS/MMS messages directly via an IP-based connection to a suitable terminal. If this terminal supports an interface to a TV set, the SMS/MMS content could also be output via a TV set. This approach requires both a suitable terminal and an IP connection between this terminal and the SMS/MMS distribution center (for disadvantages see the following).

SMS/MMS can be easily received and transmitted at home on the TV set. This thus provides new applications or user groups for SMS/MMS even without a mobile radio device.

The method in accordance with the invention enables a genuine personalization of the recipient delivered SMS/MMS based on the Tln profiles of the video control server. This is an absolute requirement for the delivery of SMS/MMS. Typically, a Tln profile of this kind can distinguish exactly which Tln is using the service at that particular moment. This enables the actual user to be identified and authenticated (by means of a PIN). This is a main advantage compared with a solution whereby an SMS/MMS is sent to a Tln terminal (STB or similar) on the basis of only an IP connection. If the subscription to the IP connection, for example, is a general one for a family, then it is not sufficient to deliver SMS/MMS on the basis of the IP connection, because, for example, a son could view SMS/MMS meant for the father.

The transmission of SMS/MMS in accordance with the invention also takes place via the video control server, that undertakes the authorizations for this service, the billing and the onward transmission by means of the SMS/MMS distribution center. It is therefore possible to bill the transmission of SMS/MMS in the original network (in this case a TV network) as is usual at present, with the SMS/MMS distribution center in this case acting only purely as a gateway. Alternative solutions where the SMS/MMS are transmitted from special terminals directly via the SSM/MMS distribution center would require the present SMS/MMS distribution centers to be expanded by adding Tln management and billing functions.

Receiving and reading SMS/MMS parallel with TV operation is possible by means of blending technology. Thus, for example, SMS/MMS-based communication while a film is running is possible.

SMS can easily be written from the IR keyboard of the STB.

MMS with image information such as TV pictures, pictures from external storage media or from external cameras can be transmitted.

The IP connection to the STB is used to send MMS. This is a simpler and also cost-optimized solution compared with the approach previously discussed where MMS image information is fetched by an additional modem connection.

If SMS and MMS are exclusively exchanged between the Tln and the IP-based video network, it is also possible by means of the method in accordance with the invention to transmit longer SMS (more text characters) or MMS with image information with larger data sizes because it is not necessary to comply with the restrictions of the present mobile radio or PSTN networks. In these cases, the video control server would also act as a distribution center for the SMS/MMS to the video Tln.

The method in accordance with the invention uses the normal present interfaces for transmission in the direction of the SMS/MMS distribution center. Communication between the video control server and STB can be realized as a manufacturer-proprietary system based on standard IP stacks (TCP/UDP on IP). This enables the method to be realized immediately.

The video control server acts as a gateway for SMS/MMS to/from its video Tln. To do this, it logs on to the SMS/MMS distribution center in the name of all its video Tln.

A video Tln is addressed internally in the video network by the video control server and is thus flexible. In conjunction with present SMS/MMS distribution centers, this is an E.164 address. If future SMS/MMS distribution centers support, for example, a uniform resource identifier (URI) as a Tln address, this would also be covered by the method in accordance with the invention.

The method guarantees a personalized delivery of SMS/MMS based on the Tln profile of the video Tln.

The video control server knows the status of the STB of the video Tln and handles incoming SMS/MMS accordingly.

The method enables a direct exchange of SMS/MMS between the video Tln via the video control server. The video control server in this case acts as video network internal SMS/MMS distribution center.

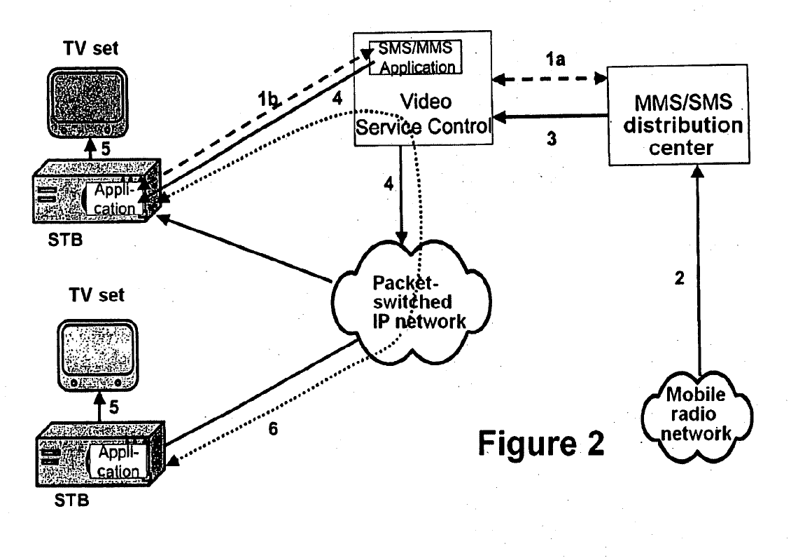

FIG. 2 supports the following examples of a description of the process in accordance with the present invention.

Registration

1a: The video control server is logged on to the SMS/MMS distribution center for all its video Tln (based for example on the E.164 PSTN call number of the video Tln).
1b: The STB application of the video Tln logs on to the SMS/MMS client on the video control server.
   Sequence
   An SMS/MMS is transmitted to a video Tln from the mobile radio network.
2. The SMS/MMS is transmitted to the PSTN call number of the video Tln and arrives at the distribution center.
3. The distribution center knows on the basis of the logon of the video control server that the video Tln can be reached via the video control server. It forwards the SMS to the video control server using a suitable protocol. On the basis of the call number, the video control server allocates the received SMS/MMS to the correct SMS/MMS client of the video Tln. Successful reception of the SMS is acknowledged by a signal back to the distribution center.
4. Because of the logon of the STB application, the SMS/MMS client knows that the STB of the video Tln is online. The Tln profile can be used to check that the actual addressed recipient has logged on. If this is so, the data content is sent to the application on the STB.
5. The data content is shown on the connected TV set.
   Option SMS/MMS are exchanged between the video Tln within the video network.
6. The video Tln can directly exchange SM/MMS through the video control server. In this case, the video control server acts as an SMS/MMS distribution center of the video network.

1.-9. (canceled)

10. A method for distributing a short message to a video user, comprising:
sending the short message to a short messages distribution center;
forwarding the message from the distribution center to a video control device that controls a service available to the video user; and
forwarding the message from the video control device to a terminal of the video user.

11. The method as claimed in claim 10,
wherein an IP protocol is used in the forwarding the message between the video control device and the terminal, and
wherein the message is forwarded from the video control device to the terminal if the terminal is online.

12. The method as claimed in claim 11, further comprising:
receiving a short message from the video user by the video control device;
determining that a recipient of the message is not managed by the video control device; and
forwarding the message to the distribution center.

13. The method as claimed in claim 11, further comprising:
receiving a short message from the video user by the video control device;
determining that a recipient of the message is managed by the video control device; and
forwarding the message to the recipient via an IP network and not by a mobile radio network.

14. The method as claimed in claim 11, wherein the message is stored at the video control device if the terminal is offline.

15. The method as claimed in claim 14, wherein the stored message is forwarded by video control device when the offline terminal goes online.

16. The method as claimed in claim 11, wherein a PSTN call number is used as an address of the video user.

17. The method as claimed in claim 11, wherein an IP address or a URI is used as an address of the video user.

18. A video control device that controls a service available to a video user,
a subscription mechanism that allows the video user to subscribe to a short message service;
a registration mechanism for informing a distribution center of an address of the subscribed user so that the distribution center forwards a message for the subscribed user to the video control device; and
a short message for the subscribed that is sent by the distribution center and forwarded to a terminal of the subscribed user.

19. The video device as claimed in claim 18,
wherein the user of the terminal is identified, and
wherein the short message is forwarded to the terminal if the identified user is the video user.

20. The video device as claimed in claim 19,
wherein a further user has not subscribed to the device, and
wherein a short message originating from the subscribed user is sent to the further user by forwarding the message to the distribution center.

21. The video device as claimed in claim 19, wherein when a plurality of users have subscribed to the device including a first user and a second user, the device acts as a distribution center, and wherein a short message originating from the first user is sent to the second user via an IP network and without entering the mobile radio network.

22. A distribution center for short messages, comprising:
a logon device to which a video user can be logged on via a video control device that controls a service available to the video user;
an incoming message from a mobile radio network that are addressed to the logged-on user; and
a distribution device that forwards the message to the video control device,
wherein the logged-on user is not in the mobile radio network.

23. The distribution center as claimed in claim 22, wherein the address is a PSTN call number.
